(19) United States
(12) Patent Application Publication
(10) Pub. No.: US 2009/0229110 A1
(43) Pub. Date: Sep. 17, 2009

(54) TOOL FOR USE IN REMOVING HEAD

(75) Inventor: Yoji Kaneko, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/271,511

(22) Filed: Nov. 14, 2008

(30) Foreign Application Priority Data
Mar. 17, 2008 (JP) 2008-068472

(51) Int. Cl. G11B 21/26; G11B 5/48

(52) U.S. Cl. 29/603.02; 29/762; 29/253; 29/244

(57) ABSTRACT

A tool is designed to be attached to an actuator having a rotary fulcrum and heads on a tip end opposite to the rotary fulcrum. The tool includes a finger inserted between a first pair of mutually adjacent suspensions which are provided with heads having mutually opposing scanning surfaces, and a partitioning plate inserted between a second pair of mutually adjacent suspensions which are provided with heads having mutually opposing back surfaces that are on opposite ends from the scanning surfaces.

### BACKGROUND OF THE INVENTION

1. Field of the Invention

The present invention generally relates to tools, and more particularly to a tool that is suited for removing a head part from an actuator of a magnetic storage apparatus.

2. Description of the Related Art

A magnetic storage apparatus has a plurality of magnetic recording media and a plurality of heads for recording information on and reproducing information from the magnetic recording media. In a magnetic disk apparatus (or a magnetic disk drive), a plurality of magnetic disks are provided coaxially at predetermined intervals. One head is provided on a tip end of a head actuator, with respect to a recording surface of each of the magnetic disks. A plurality of head parts, each including the head, are stacked. For this reason, a head assembly formed by the plurality of head parts is referred to as a Head Stack Assembly (HAS). For example, when the head fails or the serviceable life of the head ends, it is possible to replace only the head part which includes the head which failed, for example. A head clip is used when the head part is removed from the actuator and when mounting the head part on the actuator. The head clip enables the removal and mounting operations to be performed in a state where the contact or collision of the heads is prevented by the head clip.

FIG. 1 is a perspective view showing an example of a conventional head clip. A head clip 1 shown in FIG. 1 includes a positioning shaft 2, a head fixing arm 3, and a plurality of fingers 4.

FIGS. 2A, 2B and 3 are diagrams for explaining attachment of the head clip to an actuator. FIG. 2A is a side view showing a state where the head clip 1 is attached to an actuator 11, and FIG. 2B is a top view showing a state before the head clip 1 is attached to the actuator 11. As shown in FIGS. 2A and 2B, the actuator 11 has an actuator block 12, a coil 13, a unit bearing 14, a head clip insertion hole 15, a suspension 16 and a head assembly 17. A plurality of suspensions 16 and head assemblies 17 are provided on the actuator 11.

The head clip 1 is attached to the actuator 11 by inserting the shaft 2 into the hole 15 from the top of the actuator 11 and turning the head clip 1 about the shaft 2. FIG. 3 is a bottom view of the actuator 11 showing the manner inn which the head clip 1 is attached to the actuator 11. In the state where the head clip 1 is attached (or inserted) to the actuator 11, the finger 4 is inserted between two mutually adjacent suspensions 16, in order to prevent heads 18 which are provided on tip ends of the suspensions from making contact or colliding with each other in the head assembly 17.

FIG. 4 is a side view for explaining a state where one head part is removed from the head assembly 17 or, a state where one head part is mounted on the head assembly 17. FIG. 5 is a top view showing one head part. FIGS. 6A and 6B are diagrams, on an enlarged scale, showing a part of the head part surrounded by a dotted line in FIG. 5. FIG. 6A is a top view of a base plate portion, and FIG. 6B is a side view of the base plate portion.

A base plate 171 having a boss part 172 with a hole formed therein is provided on a base part of a head part 17-1 shown in FIG. 5. As shown in FIG. 6B, when mounting the head part 17-1 on the actuator 11, a calking ball 179 of a tool (not shown) is inserted into the hole of the boss part 172 to spread the inner diameter of the hole, in a state where the boss part 172 fits into an opening in a corresponding engaging part of the actuator 11, in order to mount the boss part 172 on the corresponding engaging part of the actuator 11. When removing the head part 17-1 from the actuator 11, a tapered blade of a tool is inserted between the base plate 171 and the actuator 11 from two opposing positions, in order to separate the calked boss part 172 from the corresponding engaging part of the actuator 11 and remove the head part 17-1 from the actuator 11.

However, when mounting the head part 17-1 on the actuator 11 or, when removing the head part 17-1 from the actuator 11, although the finger 4 of the head clip 1 prevents the collision of the heads 18 that are provided on the opposing sides of the two mutually adjacent suspensions 16, it is not possible to prevent collision of the opposing sides of the two mutually adjacent suspensions 16 not provided with the heads 18. Particularly when the head part 17-1 is removed from the actuator 11, the suspension 16 rises from the actuator 11 in a direction indicated by an arrow F in FIG. 7 when the calked boss part 172 is separated from the engaging part of the actuator 11, because the rigidity of the suspension 16 is relatively low. Consequently, the suspension 16 pivots clockwise in FIG. 7 about a pivotal fulcrum which is formed by the finger 4, and the head part 17-1 provided on this suspension 16 easily collides with the adjacent head part 17-1. In other words, the back surfaces of the heads 18 on the mutually adjacent suspensions easily collide with each other. FIG. 7 is a diagram for explaining the rising of the head part 17-1 from the actuator 11, and shows a side view of the actuator 11 in the state where the head clip 1 is attached thereto.

For example, an example of a tool that is used when transporting an actuator assembly is proposed in a Japanese Laid-Open Patent Application No. 2005-174459.

Conventionally, even in the state where the head clip 1 is attached to the actuator 11, the back surfaces of the heads 18 may collide with each other due to the collision of the mutually adjacent suspensions 16 when the head part 17-1 is removed from the head assembly 17 or, the head part 17-1 is mounted on the head assembly 17. As a result, there was a problem in that the heads 18 may be damaged, particularly when the suspensions 16 are deformed. Such a problem was also encountered in cases where the head part 17-1 is mounted on the actuator 11 by a method other than calking.

### SUMMARY OF THE INVENTION

Accordingly, it is a general object of the present invention to provide a novel and useful tool in which the problems described above are suppressed.

Another and more specific object of the present invention is to provide a tool which can prevent damage to a head part when an operation is made with respect to the head part of an actuator.

According to one aspect of the present invention, there is provided a tool to be attached to an actuator having a rotary fulcrum and heads on a tip end opposite to the rotary fulcrum, the tool comprising a finger configured to be inserted between a first pair of mutually adjacent suspensions which are provided with heads having mutually opposing scanning surfaces; and a partitioning plate configured to be inserted between a second pair of mutually adjacent suspensions which are provided with heads having mutually opposing back surfaces that are on opposite ends from the scanning surfaces.

According to one aspect of the present invention, it is possible to prevent damage to a head part when an operation is made with respect to the head part of the actuator.

Other objects and further features of the present invention will be apparent from the following detailed description when read in conjunction with the accompanying drawings.

### BRIEF DESCRIPTION OF THE DRAWINGS

FIG. 1 is a perspective view showing an example of a conventional head clip;

FIGS. 2A and 2B are diagrams for explaining attachment of the head clip to an actuator;

FIG. 3 is a diagram for explaining the attachment of the head clip to the actuator;

FIG. 4 is a side view for explaining a state where one head part is removed from a head assembly or, a state where one head part is mounted on the head assembly;

FIG. 5 is a top view showing one head part;

FIGS. 6A and 6B are diagrams, on an enlarged scale, showing a part of the head part surrounded by a dotted line in FIG. 5;

FIG. 7 is a diagram for explaining rising of the head part;

FIG. 8 is a plan view showing an example of a magnetic storage apparatus having the actuator;

FIG. 9 is a perspective view showing a tool in a first embodiment of the present invention;

FIGS. 10A, 10B and 10C are diagrams showing a back plate and a head clip;

FIG. 11 is a bottom view showing the actuator for explaining a manner in which a head clip is attached;

FIG. 12 is a front view for explaining attachment of the head clip to the actuator;

FIG. 13 is a front view, on an enlarged scale, showing a portion of a head part in FIG. 12;

FIG. 14 is a side view, on an enlarged view, showing a portion of the head clip in FIG. 12;

FIG. 15 is a perspective view showing a tool in a modification of the first embodiment;

FIG. 16 is a perspective view showing a tool in a second embodiment of the present invention;

FIG. 17 is a front view, on an enlarged scale, showing a calking part of the tool;

FIG. 18 is a front view showing a state where the calking part engages a boss part of the actuator;

FIGS. 19A and 19B are diagram showing the calking part on an enlarged scale;

FIG. 20 is a perspective view, on an enlarged scale, showing an actuator attaching part of the tool in a third embodiment of the present invention;

FIG. 21 is a perspective view, on an enlarged scale, showing the actuator attaching part of the tool;

FIG. 22 is a perspective view, on an enlarged scale, showing the actuator attaching part of the tool; and

FIG. 23 is a perspective view, on an enlarged scale, showing a portion of a tool in a fourth embodiment of the present invention.

### DESCRIPTION OF THE PREFERRED EMBODIMENTS

In one embodiment of the present invention, a tool (or jig) is attached to an actuator having suspensions. In a state where the tool is attached to the actuator, each finger of the tool is inserted between mutually adjacent suspensions provided with heads having mutually opposing scanning surfaces, and each partitioning plate of the tool is inserted between mutually adjacent suspensions having mutually opposing back surfaces on the opposite ends from the scanning surfaces. The fingers of the tool support the suspensions, while the partitioning plates of the tool restrict the suspensions. In this case, the tool having the fingers and the tool having the partitioning plates may be separate tools.

The collision of the scanning surfaces of the heads is prevented by the fingers of the tool, and the collision of the back surfaces of the heads is prevented by the partitioning plates of the tool.

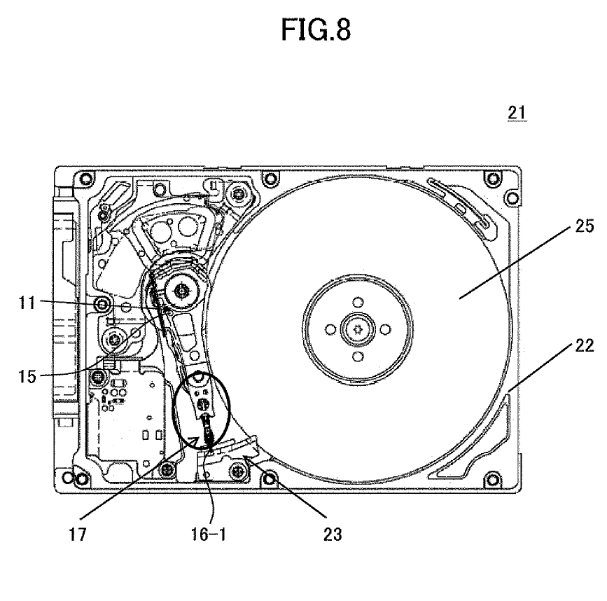

Next, a description will be given of the tool and operations using the tool, by referring to FIG. 8 and the subsequent drawings.

### First Embodiment

FIG. 8 is a plan view showing an example of a magnetic storage apparatus having the actuator. In this example, the magnetic storage apparatus is a magnetic disk apparatus using a plurality of magnetic disks as the magnetic recording media.

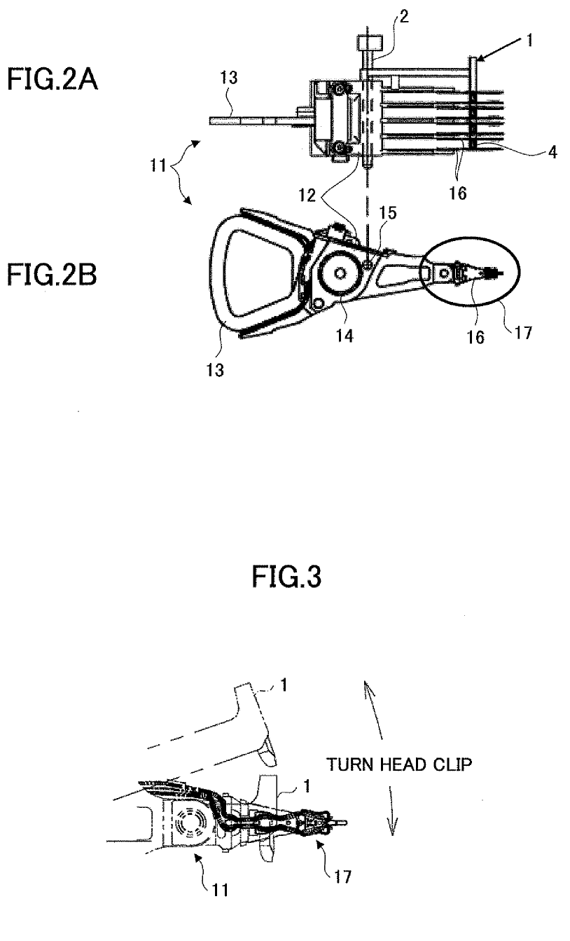

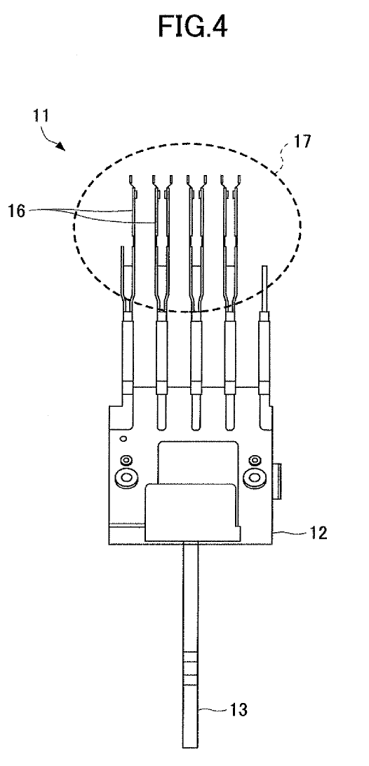

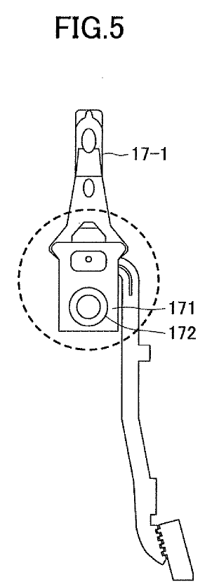

A magnetic disk apparatus 21 shown in FIG. 8 has a known structure having an actuator 11, a load and unload mechanism 23, magnetic disks 25 and the like which are provided on a base 22. The actuator 11 has the structure described above in conjunction with FIGS. 2A and 2B, and a detailed description thereof will be omitted. A head 18 is provided on a tip end of a suspension 16 of the actuator 11. The head 18 records signals on and reproduces signals from the magnetic disk 25 which is rotated by a motor (not shown), in a state where a scanning surface of the magnetic head 18 floats by a predetermined amount from a recording surface of the magnetic disk 25. The number of suspensions 16 provided on the actuator 11 and the number of heads 18 may be set to any arbitrary numbers which are two or greater.

For the sake of convenience, it is assumed that the actuator 11 is a load unload type. Hence, depending on the mode of the magnetic disk apparatus 21, the head 18 is unloaded from the load and unload mechanism 23 and is moved to a position above the magnetic disk 25 or, the head is moved from the position above the magnetic disk 25 and is loaded onto the load and unload mechanism 23. A load and unload tab 16-1, which is engageable to the load and unload mechanism 23, is provided on the tip end of the suspension 16 of the actuator 11. For example, this load and unload tab 16-1 is formed integrally on the suspension 16. The load and unload tab 16-1 is guided along a guiding surface of the load and unload mechanism 23, to thereby load and unload the head 18 by the load and unload mechanism 23. In a state where the head 18 is loaded onto the load and unload mechanism 23, the head 18 is receded to a position avoiding a position above the recording surface of the magnetic disk 25.

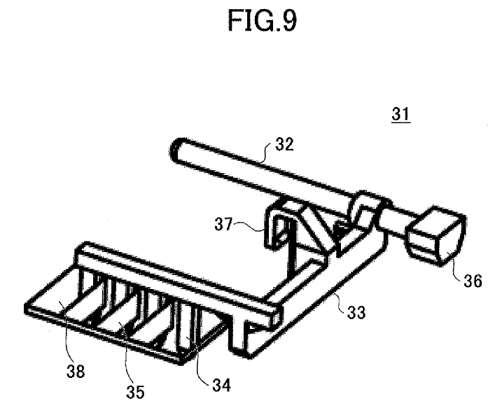

FIG. 9 is a perspective view showing a tool in a first embodiment of the present invention. In this embodiment, the present invention is applied to a head clip. A head clip 31 shown in FIG. 9 has a positioning shaft 32, a head fixing arm 33, a plurality of fingers 34, a plurality of partitioning plates 35, a knob part 36, an engaging part 37, and a back plate 38. The back plate 38 is connected to the head fixing arm 33, and each partitioning plate 35 is provided on the back plate 38. Each finger 34 is inserted between a corresponding first pair of mutually adjacent suspensions 16 which are provided with the heads 18 having mutually opposing scanning surfaces. Each partitioning plate 35 is inserted between a corresponding second pair of mutually adjacent suspensions 16 which are provided with the heads 18 having mutually opposing back surfaces that are on the opposite ends from the scanning surfaces.

The material used for parts of the head clip 31 other than the back plate 38 is not limited to a particular material, but it is desirable to form the parts of the head clip 31 other than the back plate 38 from a material which does not easily generate electrostatic. For example, the parts of the head clip 31 other than the back plate 38 is made of a material having a resistance that is approximately 1×10 Ω·m or less. Materials having the resistance that is approximately 1×10¹² Ω·m or less include conductive metals or resins, for example, and such resins include a tool stainless steel STAVAX and such resins include a conductive compound WHISTATT manufactured by Otsuka Chemical Co., Ltd., for example. The parts of the head clip 31 may be formed integrally or, the parts may be bonded to form the head clip 31. Of course, the part of the head clip 31 which makes direct contact with the actuator 11 may be formed by a material which does not easily generate electrostatic. The back plate 38 may be formed by a transparent plate. In the case of the transparent back plate 38, the head part 17-1 can easily be seen from the outside even in the state where the head clip 31 is attached to the actuator 11, to thereby improve the operation ease of the operations performed with respect to the actuator 11. When making the back plate 38 transparent, it is possible to use a conductive transparent material such as a conductive polymer ST-POLY manufactured by Achilles Corporation, for example.

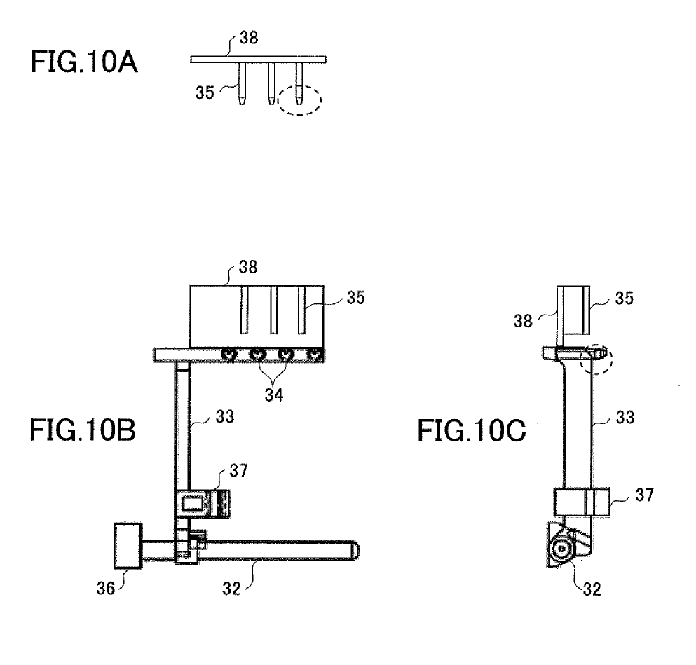

FIGS. 10A, 10B and 10C are diagrams showing the back plate 38 and the head clip 31. FIG. 10A shows a side view of the back plate 38, FIG. 10B shows a front view of the head clip 31, and FIG. 10C shows a top view of the head clip 31. A tip end portion of each partitioning plate 35 surrounded by a dotted line in FIG. 10A has a tapered shape. In addition, a tip end portion of each finger 34 surrounded by a dotted line in FIG. 10C has a tapered shape.

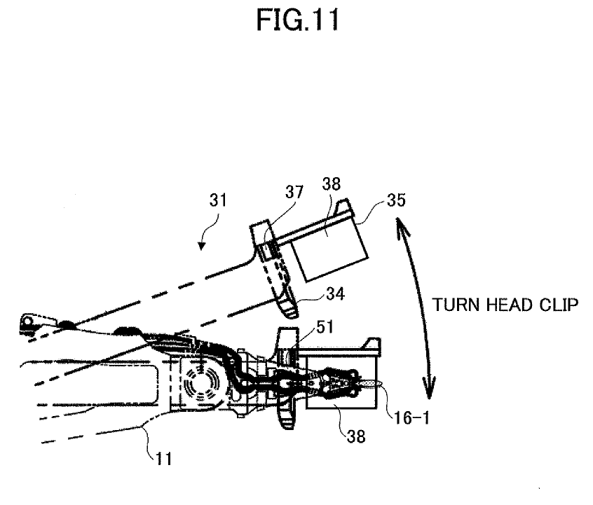

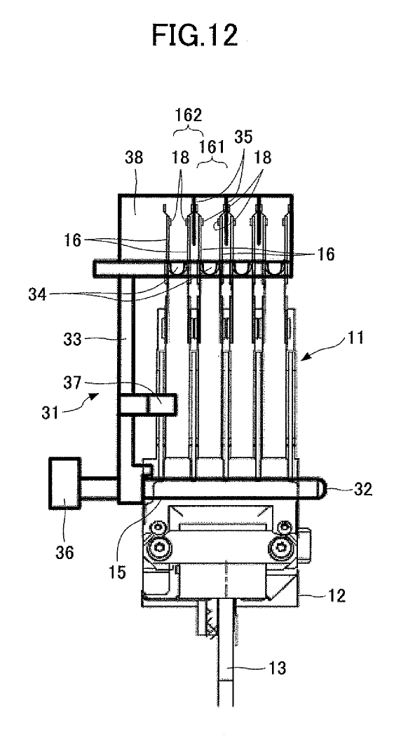

FIG. 11 is a bottom view showing the actuator 11 for explaining a manner in which the head clip 31 is attached. FIG. 12 is a front view for explaining attachment of the head clip 31 to the actuator 11.

In FIG. 11, the head clip 31 is attached to the actuator 11 in the following manner. That is, the head clip 31 is attached to the actuator 11 by inserting the shaft 32 into the hole 15 from the top of the actuator 11, and turning the knob part 36 about the shaft 32. When attaching the head clip 31 to the actuator 11, each finger 34 is first inserted between the corresponding first pair of mutually adjacent suspensions 16 which are provided with the heads 18 having mutually opposing scanning surfaces, and each partitioning plate 35 is then inserted between the corresponding second pair of mutually adjacent suspensions 16 which are provided with the heads 18 having mutually opposing back surfaces that are on the opposite ends from the scanning surfaces. When the head clip 31 is attached to the actuator 11, the engaging part 37 engages with a corresponding engaging part 51 of the actuator 11, and the head clip 31 is provisionally held so as not to easily separate from the actuator 11. The engaging part 37 of the head clip 37 and the engaging part 51 of the actuator 11 may have any shapes that would enable provisional holding of the head clip 31, and for example, the engaging parts 37 and 51 may be formed by a combination of a claw part and a recess or, a combination of a projection and a depression.

As shown in FIG. 11, the tip end portion of each of the fingers 34 and the tip end portion of each of the partitioning plates 35, which first engage the actuator 11 when attaching the head clip 31 to the actuator 11, respectively have the tapered shape as surrounded by the dotted lines in FIGS. 10C and 10A. The tapered shape is not limited to a particular shape, and may be formed by one or a plurality of sloping surfaces or curved surfaces. The tapered shape is provided in order to smoothly and positively insert the fingers 34 and the partitioning plates 35 between the corresponding first and second pairs of suspensions 16 and to prevent damage to the suspensions 16 and the like and to prevent large shock or vibration from being applied to the suspensions 16 and the like, when attaching the head clip 31 to the actuator 11.

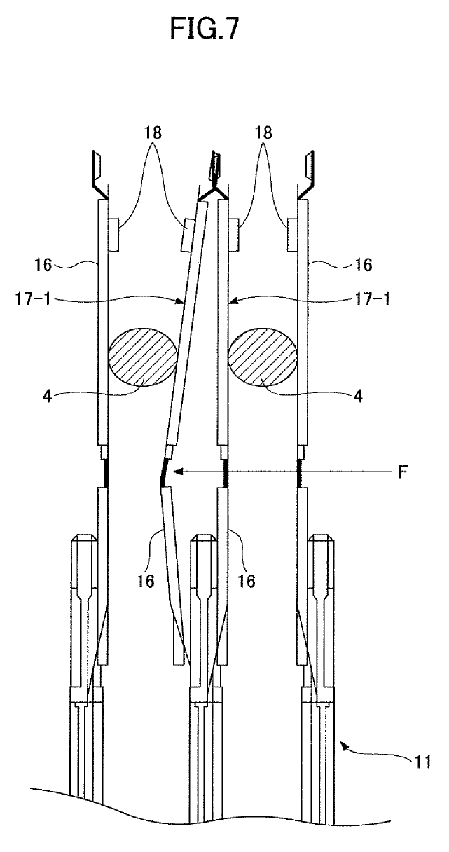

In the state where the head clip 31 is attached to the actuator 11, each finger 34 is inserted between a corresponding first pair 161 of mutually adjacent suspensions 16 which are provided with the heads 18 having mutually opposing scanning surfaces, and each partitioning plate 35 is inserted between a corresponding second pair 162 of mutually adjacent suspensions 16 which are provided with the heads 18 having mutually opposing back surfaces that are on the opposite ends from the scanning surfaces. The finger 34 supports the suspensions 16 forming the first pair 161 at a position between the rotary fulcrum of the actuator 11 and the head 18 along a longitudinal direction of the actuator 11, and prevents the scanning surfaces of the heads 18 which are provided on the tip ends of the suspensions 16 from colliding with each other. On the other hand, the partitioning plate 35 restricts the suspensions 16 forming the second pair 162 at the tip end of the actuator 11, and prevents the back surfaces of the heads 18, that is, the tip ends of the suspensions 16 forming the second pair 162, from colliding with each other. Even if the suspension 16 on the right side in FIG. 12 and forming the second pair 162 vibrates or pivots clockwise in FIG. 12 about a pivotal fulcrum which is formed by the finger 34 due to the reasons described above in conjunction with FIG. 7, a displacement of the suspension 16 exceeding a tolerable range is restricted by the partitioning plate 35, and the displaced suspension 16 will not collide with the suspension 16 (the suspension 16 on the left in FIG. 12) forming the adjacent first pair 161.

When the partitioning plates 35 make contact with the suspensions 16 when attaching the head clip 31 to the actuator 11, there is a possibility of damaging the suspensions 16. Hence, in this embodiment, a gap is formed between the tip end portions of the suspensions 16 forming the second pair 162 and the partitioning plate 35 in the state where the head clip 31 is attached to the actuator 11.

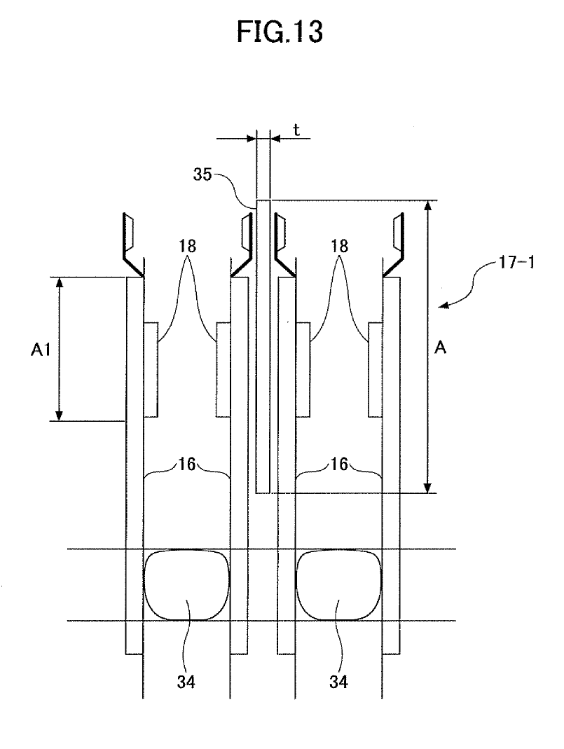

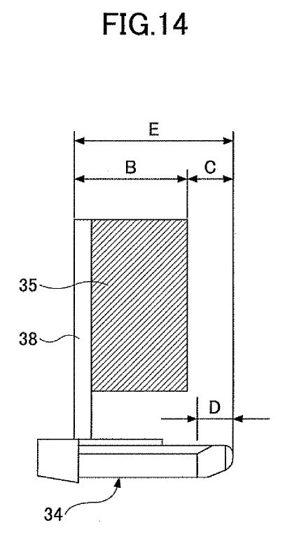

Next, a description will be given of an example of the dimensions of various parts of the head clip 31 and the actuator 11, by referring to FIGS. 13 and 14. FIG. 13 is a front view, on an enlarged scale, showing a portion of the head part 17-1 in FIG. 12, and FIG. 14 is a side view, on an enlarged view, showing a portion of the head clip 31 in FIG. 12.

In FIG. 13, A denotes a vertical width of the partitioning plate 35 (length along the longitudinal direction of the actuator 11), t denotes a thickness of the partitioning plate 35, and A1 denotes a length in the head part 17-1 from the tip end of the suspension 16 to the rear end of the head 18 (that is, the end of the head 18 closer to the rotary fulcrum of the actuator 11) along the longitudinal direction of the actuator 11. It is desirable to set the vertical width A and the length A1 to satisfy A>A1 in order to completely cover the head 19 by the partitioning plate 35 in the head part 17-1. It is desirable to set the thickness t of the partitioning plate 35 so that the partitioning plate 35 does not make contact with the suspensions 16 in the state where the head clip 31 is attached to the actuator 11, even if the displacement of the suspensions 16 caused by the insertion of the finger 34 which spreads the suspensions 16 apart and the tolerance of the thickness t of the suspension 16 are taken into consideration.

In FIG. 14, B denotes a lateral width from the back plate 38 to the lateral end of the partitioning plate 35, C denotes a length from the lateral end of the partitioning plate 35 to tip end of the finger 34, D denotes a length of the tapered part at the tip end of the finger 34, and E denotes a lateral width from the back plate 38 to the tip end of the finger 34. It is desirable to satisfy the relationships C>D and B=E−C in order for the tapered part of the finger 34 to pass between the first pair 161 of the adjacent suspensions 16 and for the linear part of the finger 34 to begin entering between the first part 161 of the adjacent suspensions 16 before the partitioning plate 35 begins to enter between the second pair 162 of the adjacent suspensions 16.

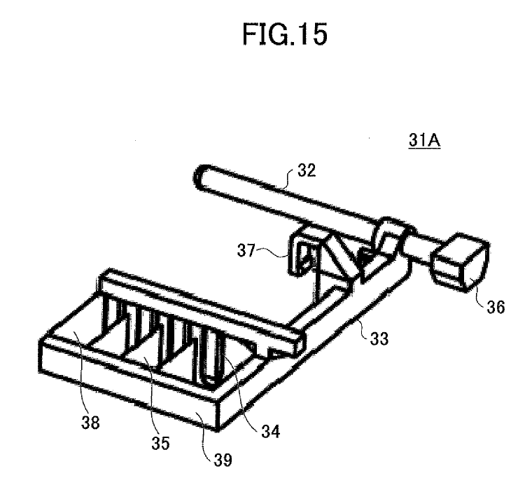

FIG. 15 is a perspective view showing a tool in a modification of the first embodiment. In FIG. 15, those parts that are the same as those corresponding parts in FIG. 9 are designated by the same reference numerals, and a description thereof will be omitted. In this modification, a head clip 31A further has a cover 39. The cover 39 extends in a direction approximately perpendicular to the longitudinal direction of the actuator 11, and protects the tip end part of the actuator 11 in a state where the head clip 31A is attached to the actuator 11. In this example, the cover 39 is integrally provided on the head fixing arm 33, however, the cover 39 may be a separate body which is connected or bonded to the head fixing arm 33. By providing the cover 39, it is possible to more positively protect the head part 17-1 in the state where the head clip 31A is attached to the actuator 11.

According to this embodiment and this modification, the fingers of the tool (head clip 31 or 31A) prevent the collision of the scanning surfaces of the heads, and the partitioning plates of the tool (head clip 31 or 31A) prevent the collision of the back surfaces of the heads, when removing the head part from the actuator or when mounting the head part on the actuator.

### Second Embodiment

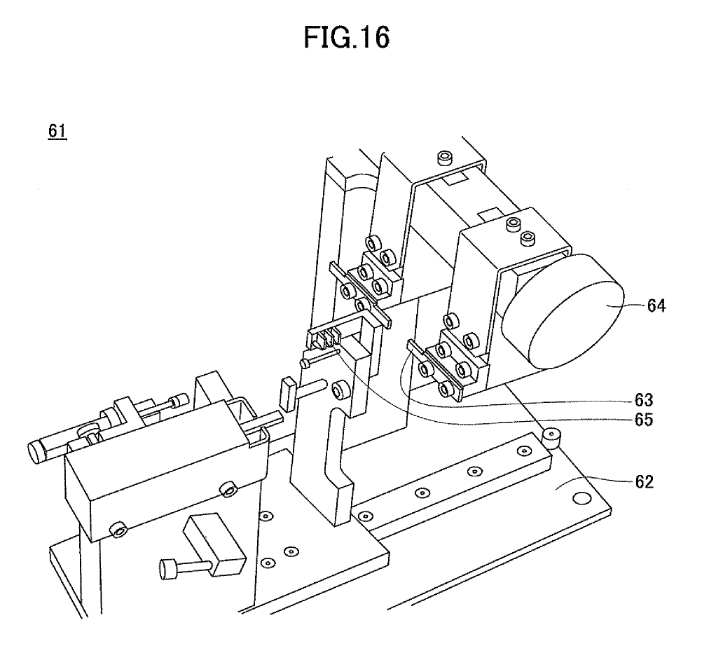

FIG. 16 is a perspective view showing a tool in a second embodiment of the present invention. In this embodiment, the present invention is applied to a tool (or jig) which removes the head part from the actuator. As shown in FIG. 16, a tool 61 has a base 62, a calking part 63, a knob 64, an actuator mounting part 65 and the like.

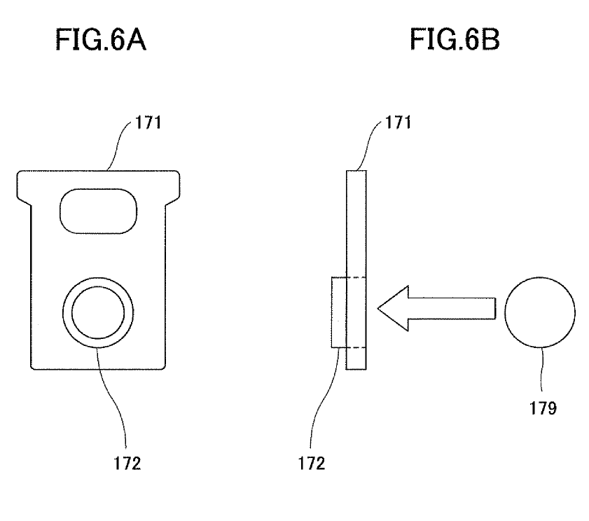

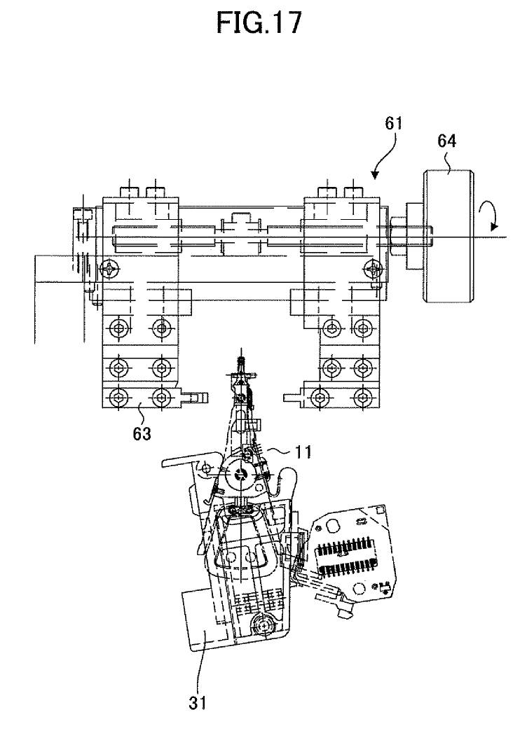

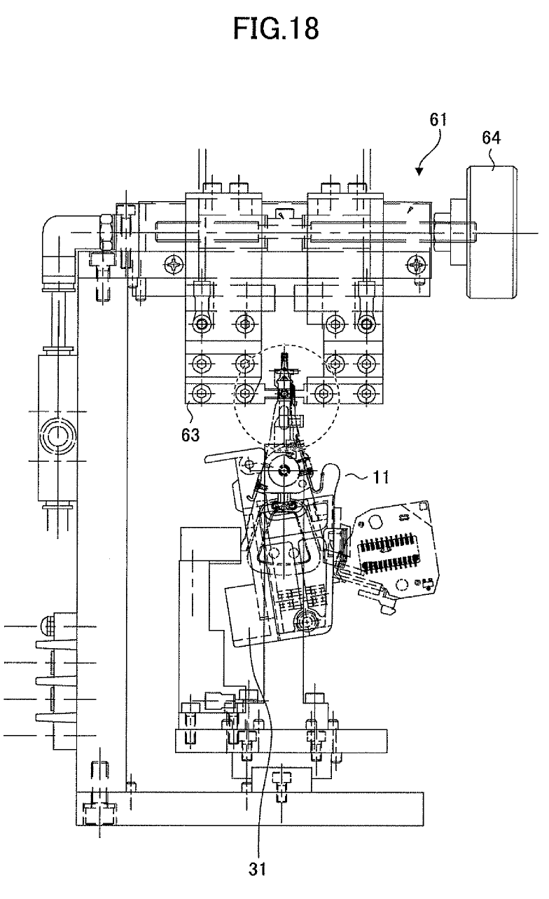

FIG. 17 is a front view, on an enlarged scale, showing the calking part 63 of the tool 61. FIG. 17 shows a state where the actuator 11 having the head clip 31 attached thereto is set on the actuator mounting part 65. the actuator 11 may be set on the actuator mounting part 65 by a known method, and detailed description and illustration of the setting method will be omitted in this specification. By turning the knob 64 in the state where the actuator 11 is set on the actuator mounting part 65, the calking part 63 moves in a direction so as to engage the head part 17-1 of the actuator 11. In a state shown in FIG. 18, the calking part 63 engages the boss part 172 (shown in FIGS. 6A and 6B) of the actuator 11. FIG. 18 is a front view showing the state where the calking part 63 engages the boss part 172 of the actuator 11.

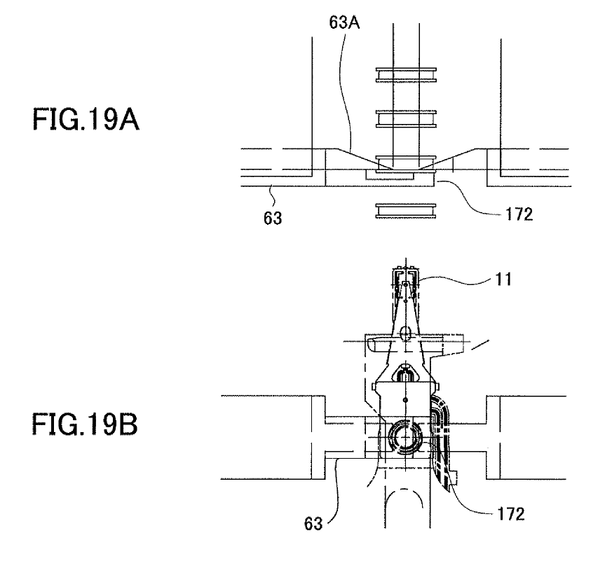

FIGS. 19A and 19B are diagram showing the calking part 63 on an enlarged scale. FIG. 19A shows a plan view of the tool 61, and FIG. 19B shows a front view of the tool 61. When removing the head part 17-1 from the actuator 11, a tapered blade 63A of the calking part 63 of the tool 61 is inserted between the base plate 171 and the actuator 11 from two opposing positions, in order to separate the calked boss part 172 from the corresponding engaging part of the actuator 11 and remove the head part 17-1 from the actuator 11.

When removing the head part 17-1 from the actuator 11 in this manner, the head part 17-1 easily collides with the adjacent head part 17-1 as described above in conjunction with FIG. 7. However, because the head clip 31 is attached to the actuator 11, the fingers 34 and the partitioning plates 35 of the head clip 31 prevent the collision of the mutually adjacent suspensions 16.

When mounting the head part 17-1 on the actuator 11, the calking ball of the tool may be used as described above in conjunction with FIGS. 6A and 6B, to basically perform an operation in reverse to the operation performed using the calking part 63, and detailed description and illustration of the mounting method will be omitted in this specification.

According to this embodiment, the fingers of the tool (head clip 31) prevent the collision of the scanning surfaces of the heads, and the partitioning plates of the tool (head clip 31) prevent the collision of the back surfaces of the heads, when removing the head part from the actuator or when mounting the head part on the actuator.

### Third Embodiment

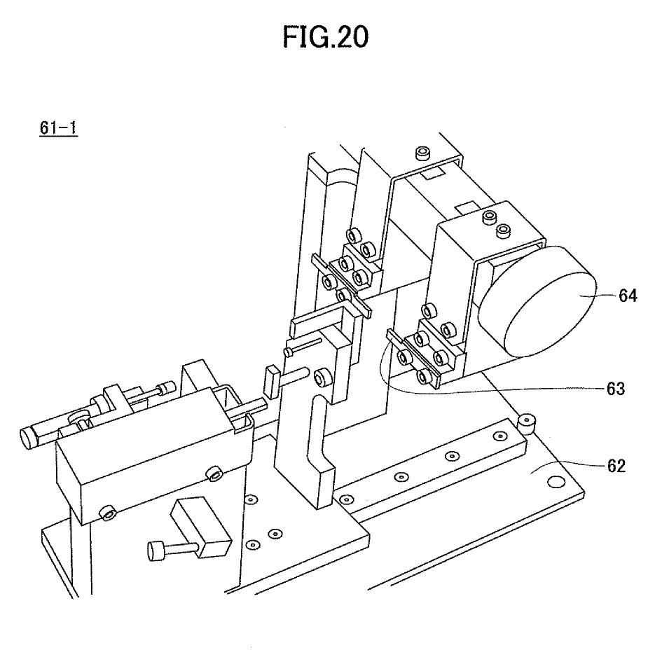

FIG. 20 is a perspective view, on an enlarged scale, showing an actuator attaching part of the tool in a third embodiment of the present invention. In FIG. 20, those parts that are the same as those corresponding parts in FIG. 16 are designated by the same reference numerals, and a description thereof will be omitted.

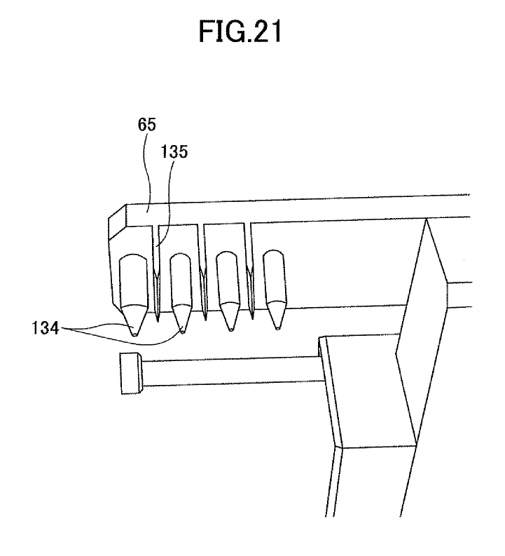

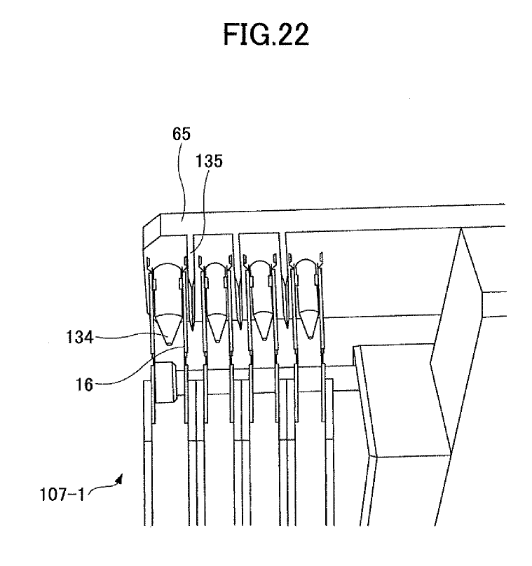

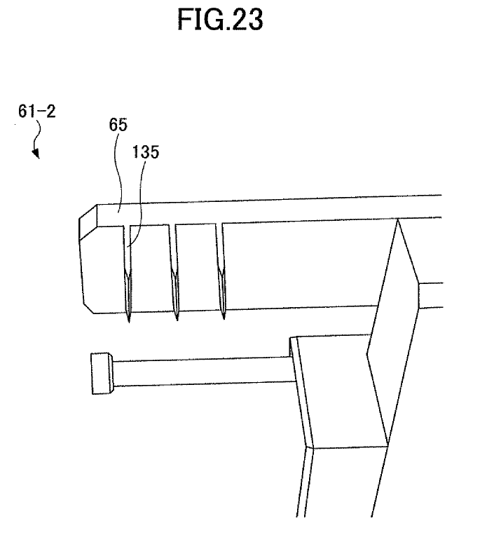

FIG. 21 is a perspective view, on an enlarged scale, showing an actuator attaching part 65 of a tool 61-1, and FIG. 22 is a perspective view, on an enlarged scale, showing an actuator 11 set on the actuator attaching part 65 of the tool 61-1. In FIGS. 21 and 22, fingers 134 and partitioning plates 135 provided on the actuator mounting part 65 respectively correspond to the fingers 34 and the partitioning plates 35 of the head clip 31 of the first embodiment. When the actuator 11 is set on the actuator mounting part 65 by a known method, the fingers 134 and the partitioning plates 135 of the actuator mounting part 65 are inserted between the corresponding adjacent suspensions 16 and function similarly to the fingers 34 and the partitioning plates 35 of the head clip 31 of the first embodiment.

It is desirable to form the fingers 134 and the partitioning plates 135 from a material which does not easily generate electrostatic. For example, the fingers 134 and the partitioning plates 135 are made of a metal or resin having a resistance that is approximately 1×10¹² Ω·m or less. In addition, the fingers 134 and the partitioning plates 135 may be formed integrally on a part of the actuator mounting part 65.

According to this embodiment, the fingers of the tool (tool 61-1) prevent the collision of the scanning surfaces of the heads, and the partitioning plates of the tool (tool 61-1) prevent the collision of the back surfaces of the heads, when removing the head part from the actuator or when mounting the head part on the actuator.

### Fourth Embodiment

FIG. 23 is a perspective view, on an enlarged scale, showing a portion of a tool in a fourth embodiment of the present invention. In FIG. 23, those parts that are the same as those corresponding parts in FIG. 21 are designated by the same reference numerals, and a description thereof will be omitted.

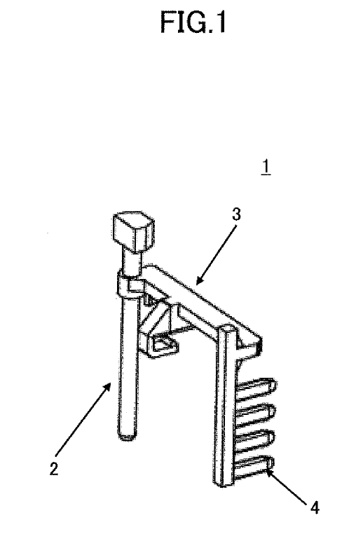

In the third embodiment described above, the fingers 134 and the partitioning plates 135 are provided on the tool 61-1. On the other hand, in this fourth embodiment, the actuator 11 is set on a tool 61-2 having the partitioning plates 135 in a state where an existing head clip 1 shown in FIG. 1, for example, is attached to the actuator 11.

It is desirable to form the partitioning plates 135 from a material which does not easily generate electrostatic. For example, the partitioning plates 135 are made of a metal or resin having a resistance that is approximately 1×10¹² Ω·m or less. In addition, the partitioning plates 135 may be formed integrally on a part of the actuator mounting part 65.

According to this embodiment, the fingers of the tool (head clip 1) prevent the collision of the scanning surfaces of the heads, and the partitioning plates of the tool (tool 61-2) prevent the collision of the back surfaces of the heads, when removing the head part from the actuator or when mounting the head part on the actuator. Further, it is possible to effectively utilize the existing head clip.

In the embodiments described above, the actuator 11 is the load and unload type. However, the actuator to which the tools of the described embodiments may be applied is of course not limited to the load and unload type.

This application claims the benefit of a Japanese Patent Application No. 2008-068472 filed Mar. 17, 2008, in the Japanese Patent Office, the disclosure of which is hereby incorporated by reference.

Further, the present invention is not limited to these embodiments, but various variations and modifications may be made without departing from the scope of the present invention.

What is claimed is:

1. A tool to be attached to an actuator having a rotary fulcrum and heads on a tip end opposite to the rotary fulcrum, said tool comprising:
a finger configured to be inserted between a first pair of mutually adjacent suspensions which are provided with heads having mutually opposing scanning surfaces; and
a partitioning plate configured to be inserted between a second pair of mutually adjacent suspensions which are provided with heads having mutually opposing back surfaces that are on opposite ends from the scanning surfaces.

2. The tool as claimed in claim 1, wherein:
the finger is inserted at a position between the rotary fulcrum of the actuator and the heads along a longitudinal direction of the actuator; and
the partitioning plate is inserted at tip ends of the actuator.

3. The tool as claimed in claim 1, further comprising:
a positioning shaft; and
a head fixing arm having a base part connected to the positioning shaft and a tip end connected to the finger and the partitioning plate,
wherein the finger is inserted between the first pair of the mutually adjacent suspensions and the partitioning plate is inserted between the second pair of the mutually adjacent suspensions when the tool is turned with respect to the actuator in a state where the positioning shaft is inserted into a head clip insertion hole that is provided in the actuator.

4. The tool as claimed in claim 3, wherein the finger and the partitioning plate have shapes such that the finger is first inserted between the first pair of the mutually adjacent suspensions and the partitioning plate is thereafter inserted between the second pair of the mutually adjacent suspensions when the tool is turned with respect to the actuator.

5. The tool as claimed in claim 3, wherein:
a part of the finger that is first inserted between the first pair of the mutually adjacent suspensions when the tool is turned with respect to the actuator has a tapered shape; and
a part of the partition that is first inserted between the second pair of the mutually adjacent suspensions when the tool is turned with respect to the actuator has a tapered shape.

6. The tool as claimed in claim 4, wherein:
a part of the finger that is first inserted between the first pair of the mutually adjacent suspensions when the tool is turned with respect to the actuator has a tapered shape; and
a part of the partition that is first inserted between the second pair of the mutually adjacent suspensions when the tool is turned with respect to the actuator has a tapered shape.

7. The tool as claimed in claim 3, further comprising:
a transparent plate provided on the head fixing arm and extending along a direction which the head fixing arm extends from the positioning shaft,
wherein the partitioning plate is provided on the transparent plate.

8. The tool as claimed in claim 4, further comprising:
a transparent plate provided on the head fixing arm and extending along a direction which the head fixing arm extends from the positioning shaft,
wherein the partitioning plate is provided on the transparent plate.

9. The tool as claimed in claim 5, further comprising:
a transparent plate provided on the head fixing arm and extending along a direction which the head fixing arm extends from the positioning shaft,
wherein the partitioning plate is provided on the transparent plate.

10. The tool as claimed in claim 6, further comprising:
a transparent plate provided on the head fixing arm and extending along a direction which the head fixing arm extends from the positioning shaft,
wherein the partitioning plate is provided on the transparent plate.

11. The tool as claimed in claim 7, further comprising:
a cover extending in a direction approximately perpendicular to a longitudinal direction of the actuator in a state where the tool is attached to the actuator, and configured to protect the tip end of the actuator.

12. The tool as claimed in claim 8, further comprising:
a cover extending in a direction approximately perpendicular to a longitudinal direction of the actuator in a state where the tool is attached to the actuator, and configured to protect the tip end of the actuator.

13. The tool as claimed in claim 9, further comprising:
a cover extending in a direction approximately perpendicular to a longitudinal direction of the actuator in a state where the tool is attached to the actuator, and configured to protect the tip end of the actuator.

14. The tool as claimed in claim 10, further comprising:
a cover extending in a direction approximately perpendicular to a longitudinal direction of the actuator in a state where the tool is attached to the actuator, and configured to protect the tip end of the actuator.

15. The tool as claimed in claim 3, further comprising:
a cover extending in a direction approximately perpendicular to a longitudinal direction of the actuator in a state where the tool is attached to the actuator, and configured to protect the tip end of the actuator.

16. The tool as claimed in claim 1, comprising:
a plurality of said fingers: and a plurality of said partitioning plates.

17. The tool as claimed in claim 1, further comprising:
a tapered blade configured to be inserted between a head part and the actuator, when removing from the actuator the head part comprising a single suspension and a single head provided on said single suspension.
